(19) United States
(12) Patent Application Publication
(10) Pub. No.: US 2016/0223167 A1
(43) Pub. Date: Aug. 4, 2016

(54) Solder-Mask-Related Safety Accommodation Arrangement for LED Lighting Modules

(71) Applicant: CREE, INC., DURHAM, NC (US)

(72) Inventors: Kurt Wilcox, Libertyville, IL (US); Mark Dixon, Morrisville, NC (US); Jason Taylor, Cary, NC (US)

(21) Appl. No.: 14/612,885

(22) Filed: Feb. 3, 2015

(51) Int. Cl. F21V 15/015; F21K 99/00; F21V 23/00

(52) U.S. Cl. CPC F21V 15/015; F21V 23/005; F21K 9/90; F21Y 2101/02

(57) ABSTRACT

An LED apparatus which includes (a) an electrical circuit board having an electrically-insulated substrate with conductive zones laminated thereon, (b) a selectively-applied dielectric layer, such as a solder-mask layer, deposited or otherwise adhered to portions of the circuit board, the dielectric layer having a thickness and material composition sufficient such that the fire and electrical enclosure requirements of UL8750, UL746E and UL746C are met, and (c) one or more LEDs connected to the circuit board at designated connection sites thereon.

### FIELD OF THE INVENTION

The invention relates generally to the field of LED lighting systems and, more particularly, relates to circuit boards on which LEDs are mounted within LED lighting fixtures.

### BACKGROUND OF THE INVENTION

In the field of lighting, many different types of light sources have been developed. Recently, LED light sources involving multi-LED arrays, each with a large number of LED packages, have been developed as a means of bringing the many advantages of LED lighting—LED efficiency and long life—into the general illumination field. In particular, such LED light fixtures have been developed for use in outdoor settings, including by way of example lighting for parking lots, roadways, display areas and other large areas.

The product safety of lighting fixtures creates an important issue for the configuration of LED fixtures, and such fixtures are most often required to comply with standards put forward by organizations such as Underwriters Laboratories Inc. (UL) in order to gain acceptance in the marketplace. A number of standards may be applied during the process of product acceptance. Among such standards are: (1) UL8750 (Light Emitting Diode (LED) Equipment for Use in Lighting Products); (2) UL746C (Polymeric Materials—Use in Electrical Equipment Evaluations): and (3) UL746E (Polymeric Materials—Industrial Laminates, Filament Wound Tubing, Vulcanized Fibre, and Materials Used in Printed-Wiring Boards).

Some of these standards deal with the overall end products and their components in the field of LED lighting fixtures (UL8750), some in specific applications such as insulating or enclosing (UL746C), and some with the physical, electrical, flammability, thermal and other performance properties of polymeric materials (UL746E). As can be seen from these general descriptions, the UL standards are often interrelated, and products and/or components may have multiple standards which may be applied during acceptance testing.

As the field of LED lighting continues to develop and mature, there is a need for increased efficiency, not only with respect to power and lighting but also with respect to manufacturing. One such area of developmental focus relates to the enclosures of LED lighting fixtures. U.S. Pat. No. 7,938,558 (Wilcox et al.) discloses an LED mounting board with its and other components and having a safety barrier which meets certain safety standards in a cost-effective manner. U.S. Pat. No. 8,070,306 (Ruud et al.) discloses LED lighting fixtures which integrate the heat-sink structures into the enclosure configuration, thereby reducing parts count and simplifying the manufacturing process.

The need to simplify manufacturing and reduce the number of components within LED light fixtures and fixture components is on-going and continuous, particularly as LED lighting becomes more and more widespread within the lighting marketplace. One way to simplify manufacturing and reduce cost and components is to combine the functions of two or more components into a single component. This invention is one such innovation, and one which yields unexpected results. A solder-mask layer on a circuit board is typically about 10-12μ in thickness and in some cases even thinner, and serves the purpose of preventing solder from flowing onto areas of the board for which solder is not intended. The present invention combines the traditional function of a solder mask with that of providing a safety barrier/enclosure satisfying the stringent fire and electrical requirements as outlined in at least the three Underwriters Laboratories standards documents introduced above.

UL8750 (for LED-based lighting equipment) lists a set of requirements for polymeric enclosures, the most stringent of which are for direct-connected electrical circuits. (Direct-connected electrical circuits are defined by UL as circuits connected directly to a power source with no isolating transformer or optical isolator and which utilize voltages greater than 42.4V peak AC or 60 VDC. There are also limitations on the maximum current in such circuits.) Among the requirements are that a “fire and electrical” enclosure be provided and that the enclosure pass a flammability test designated as 5VA.

The 5VA flammability test is described in UL746C and is informally summarized as follows: A 5-inch flame is applied to the enclosure five times for 5 seconds with a 5-second interval between each application. The test enclosure is placed 12 inches above a layer of absorbent 100% cotton. After such flame application, the following results must be obtained: (a) The material shall not continue to burn for more than 1 minute after the fifth 5-second application of the test flame, with an interval of 5 seconds between applications of the flame. (b) Flaming drops or flaming or glowing particles that ignite surgical cotton 305 mm (12 inch) below the test specimen shall not be emitted by the test sample at any time during the test. (c) No visible flame shall be observed on the surface of the enclosure opposite to the surface that the test flame is applied during the test. In addition, unless otherwise specified in the relevant end-product standard, no opening greater than 3 mm shall appear after the test and the sample has cooled for 30 seconds.

The electrical tests related to electrical enclosures are also challenging. A layer of solder mask is a conformal coating, and the abrasion resistance test for conformal coatings is particularly stringent. This test is described in UL 746E and is informally summarized as follows: The test sample is scratched (at 5 mm between scratches) with a hardened steel pin having a rounded point with a 0.25 mm radius. The speed of pin movement and the force on the pin are specified in detail. After scratches are made, the test sample is subjected to an electric strength test by applying a 2,000V_{RMS} test voltage across the conformal coating which results in no breakdown of the coating layer.

These two tests are described as representing the most difficult safety-acceptance challenges faced in order to use a solder-mask layer as a fire and electrical enclosure for LED apparatus. Among the other standards which apply are tests related to impact, UV resistance, hot wire ignition, and high ampere arc ignition.

Increased product safety can be costly to achieve, both in terms of the economic cost associated with providing safety as well as with the loss of lighting performance such as reduced optical efficiency. The optical reflectivity of the solder-mask layer impacts the optical output of the LED apparatus such that having a high reflectivity of the region around the LEDs is advantageous, and some solder-mask materials have somewhat higher reflectivity than others.

Thus there is a need for LED apparatus which can better serve the requirements LED lighting fixtures, which have high optical efficiency, are less complex with lower parts count and which meet the safety standards the marketplace demands.

### OBJECTS OF THE INVENTION

It is an object of this invention to provide LED apparatus which overcomes certain shortcomings of the prior art by reducing complexity and simplifying the manufacturing process.

An object of the invention is to provide LED apparatus which combines the functions of plural components into a single component in order to enclose a portion of the circuit board containing LEDs in a manner satisfying the necessary UL requirements.

An object of the invention is to provide LED apparatus which achieves the fire and electrical product safety demanded by the marketplace.

Another object of the invention is to provide LED apparatus which achieves such safety in a cost-effective manner.

These and other objects of the invention will be apparent from the following descriptions and the drawings.

### SUMMARY OF THE INVENTION

The invention is LED apparatus which provides safe enclosure of electrical circuitry by satisfying a set of stringent safety standards for the enclosures in which such LED apparatus are encased. More specifically, the invention is an LED apparatus which includes (a) an electrical circuit board having an electrically-insulated substrate with conductive zones laminated thereon, (b) a selectively-applied dielectric layer adhered to portions of the circuit board, the dielectric layer having a thickness and material composition sufficient such that the fire and electrical enclosure requirements of UL8750, UL746E and UL746C are met, and (c) one or more LEDs connected to the circuit board at designated connection sites thereon.

In key embodiments, the selectively-applied dielectric layer is a solder mask. Thus, by having a solder mask of sufficient thickness and composition, the solder provides a dual function, namely, its normal masking function and the additional function of providing suitable enclosure to LED circuit boards. The invention provides important manufacturing efficiencies.

In certain embodiments of the inventive LED apparatus, the solder-mask layer comprises Taiyo PSR4000 LEW3. In some embodiments, the solder-mask layer, such as the Taiyo PSR4000 LEW3 solder mask, has a thickness in excess of about 60 microns. Other compositions will re referred to below.

In some specific embodiments of the inventive LED apparatus, the region of the circuit board surrounding the LEDs is a lighting region, and the circuit board further includes non-LED electrical components on one or more areas of the circuit board outside of the lighting region. In some such embodiments, the one or more areas outside of the lighting region of the circuit board include a solder-mask layer having a thickness of not more than one-third that of the solder-mask layer on the lighting region. In other of such embodiments, the lighting region includes one or more subregions which do not include conductive zones, and the subregions include a solder-mask layer having a thickness of not more than one-third that of the solder-mask layer on the lighting region.

In another aspect of the inventive LED apparatus, the solder mask is applied by a silk-screening process, with application involving a single pass or in some cases plural passes.

The selectively-applied dielectric layer of certain embodiments is of a single material, but plural materials applied in plural passes is also possible.

The term “conductive zones laminated thereon” as used herein with respect to a circuit board refers broadly to the conductive portions of a circuit board. Such circuit boards are typically printed circuit boards, and the conductive zones are typically made of copper which has been laminated onto a non-conductive surface of a board substrate and then all but the intended conductive zones are chemically etched away. Conductive zones include what are typically referred to as traces but may also include areas which are larger than required for suitable conductivity and may be used for other purposes such as shielding or for thermal control. The use of this terminology is not intended to be limiting as to the materials and methods used in the fabrication of the conductive zones of a circuit board.

The term “selectively-applied” as used herein with respect to the dielectric layer, such as a solder mask, refers to depositing or otherwise adhering a layer of material to predetermined portions of the circuit board.

The term “lighting region” as used herein refers to the area of a circuit board which is populated by LEDs and does not include other electrical and electronic components.

The term “LED” as used herein refers to an LED package which include a lens. As used herein, such LED packages may contain a single light-emitting diode or a group of light-emitting diodes mounted under the lens. The lens may be made of polymeric materials.

In descriptions of this invention, including in the claims below, the terms “comprising,” “including” and “having” (each in their various forms) and the term “with” are each to be understood as being open-ended, rather than limiting, terms.

### BRIEF DESCRIPTION OF THE DRAWINGS

FIG. 1 is a top view of an embodiment of a circuit board illustrating various aspects of the present invention.

FIG. 2 is a cross-sectional illustration of a circuit board showing layers including board substrate and conductor traces, an LED package, and a standards-satisfying layer of solder mask.

FIG. 3 is a cross-sectional illustration of a circuit board showing layers including board substrate and conductor traces, an LED package, and a standards-satisfying layer of solder mask on a lighting area of the board and a thinner layer of solder mask on a region outside of the lighting area.

### DETAILED DESCRIPTION OF EXEMPLARY EMBODIMENTS

Using a standards-satisfying layer of solder mask enables regions of a circuit board within LED apparatus to serve as the enclosure for such regions of the circuit board without the use of any additional mechanical barriers. As described above, the use of such a layer of solder mask satisfies all of the fire and electrical requirements which are placed on enclosures of LED apparatus.

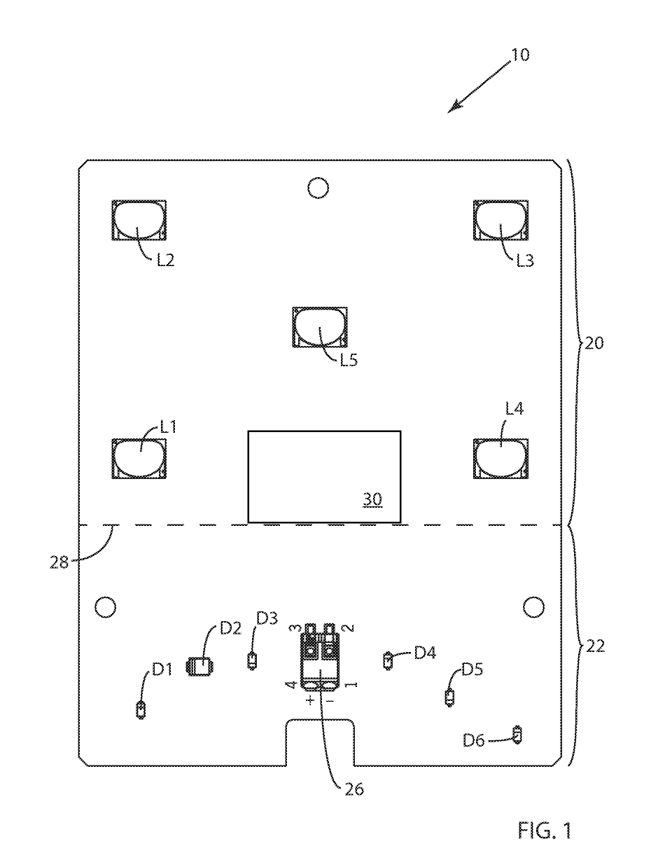

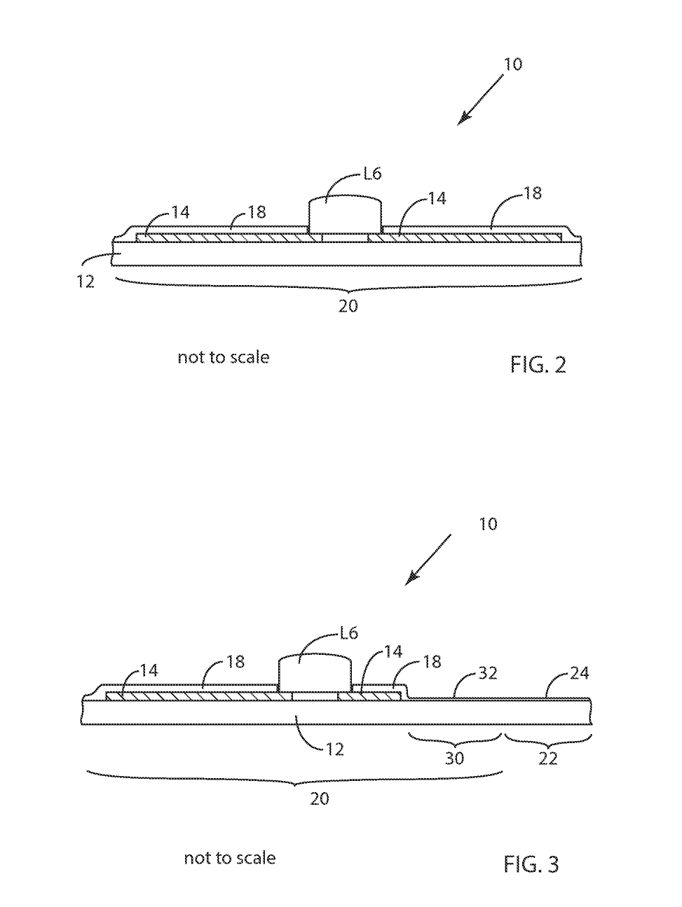

FIG. 1 is a top view of an embodiment 10 of a circuit board (also referred to below as circuit board 10) illustrating various aspects of the present invention. FIG. 2 is a cross-sectional illustration of a portion of circuit board 10 showing layers including a board substrate 12 and conductive zones 14 (hereinafter called conductor traces 14 in the description of circuit board 10), an LED package L6, and a standards-satisfying layer 18 of solder mask. LED package L6 is so labeled because it is not intended to represent any of LED-packages L1-L5 as shown in FIG. 1. FIG. 3 is a cross-sectional illustration of another portion of circuit board 10 showing layers including a board substrate 12 and conductor traces 14, an LED package L6, a standards-satisfying layer 18 of solder mask, and solder-mask layers 24 and 32 which are much thinner than solder-mask layer 18.

Referring to FIGS. 1-3 together, board substrate 12 provides the primary structure for circuit-board embodiment 10. Board substrate 12 may be made of a single layer of material such as FR-4 (Flame Resistant 4), a glass-reinforced epoxy laminate well-known to those knowledgeable in the field of electrical circuitry or may be a multilayer structure such as a metal core printed circuit board often used in application in which additional mechanical strength is required or in higher-temperature applications. The component-side layer of such a multilayer substrate is, of course, insulated. These example materials for substrate 12 are not intended to be limiting; other materials may be used for substrate 12 within the scope of this invention.

Conductor traces 14 are laminated on board substrate 12 according to the topology of the specific LED-apparatus circuit. Traces 14 are typically made of copper which is laminated onto substrate 12 and then portions which are not to become conductor traces 14 for circuit board embodiment 10 are chemically etched away, leaving conductor traces 14 in place. Other conductive materials may be used for conductor traces 14; discussion herein of the use of copper is not intended to be limiting with respect to the present invention.

An unusually thick layer 18 of solder mask is deposited onto circuit board 10 over a lighting region 20 surrounding the LEDs which are designated as L1, L2, L3, L4 and L5. Lighting region 20 is indicated by the ellipsis on the upper lefthand side of FIG. 1 and generally includes the upper portion of circuit board 10 as indicated by the region above dotted line 28. Prior to this present invention, solder-mask layers have typically been applied to circuit boards at thicknesses of about 10-12μ (microns) or even thinner. When applied at such thicknesses to circuit-board areas similar to lighting region 20 and when such circuit boards are powered in a direct-connected fashion as defined by UL8750, the solder mask does not meet performance standards required to be classified as enclosing such a circuit board in a polymeric enclosure. However, by configuring circuit board 10 with solder-mask layer 18 with a solder-mask of suitable composition and sufficient thickness, a layer of such thickness serves the purpose of meeting the fire and electrical standards of a polymeric enclosure for a direct-connected circuit for lighting region 20.

A particularly good material for solder-mask layer 18 is Taiyo PSR4000 LEW3. This material is an epoxy solder mask which includes diethylene glycol monoethyl ether acetate, acetophenone derivative, and dipropylene glycol monomethyl ether, and it is manufactured by Taiyo Ink Manufacturing Co., Ltd. of Saitama, Japan. Deposited at thicknesses in excess of 60μ, this material allows the stringent fire and electrical enclosure requirements of UL8750, UL746E and UL746C to be met; furthermore, it has been found that Taiyo PSR4000 LEW3 has a high optical reflectivity, which is also advantageous.

Thicknesses sufficient to satisfy the fire and electrical enclosure requirements of UL8750, UL746E and UL746C depend, of course, on the specific composition used. Sufficient thicknesses achieving this advantage can vary; it is believed that appropriate thicknesses in some cases may be as much as 100μ.

While Taiyo PSR4000 LEW3 is considered a particularly good solder mask for use in this invention, other solder mask materials, deposited or otherwise adhered to the lighting region 20 of circuit board 10 at substantially above-normal thicknesses depending on the specific materials chosen, are believed to provide the standard-satisfying performance characterized herein. Some suitable examples include Electra EMP 110-WT05, an aqueous solder-mask material using two-component epoxy technology, available from Electra Polymers Ltd., and Stabilux, a silicone material having high dielectric strength available from Bergquist. Also, it is expected that coverlay materials such as polyimide, from Dupont and other chemical suppliers, used in sufficient thickness will provide the standard-satisfying performance characterized herein.

As illustrated in FIG. 1, circuit board 10 includes a set of subregions 30 which lie within lighting region 20 but which do not include conductive zones 14. In these cases, solder mask layers 32 (see also FIG. 3) having thicknesses less than about one-third of the thickness of layer 18 may be used.

As also illustrated in FIG. 1, circuit board 10 includes a region 22 outside of lighting region 20. Region 22 outside of lighting region 20 includes other non-LED electrical components D1-D6 which are mounted onto circuit board 10 in a fashion similar to LEDs L1-L5. In circuit board 10, other electrical components D1-D6 are diodes, and circuit board 10 also includes a power connector 26 supplying current to board 10. As shown, other electrical components D1-D6 and connector 26 are not properly enclosed and require enclosure protection other than solder-mask layer 18.

As described above, each LED L1-L5 on circuit board 10 includes its own polymeric lens and therefore such lenses serve to satisfy the polymeric enclosure requirements. In circuit board embodiment 10, region 22 outside of lighting region 20 must be enclosed with some other enclosure structure which is not shown in the figures and which is not part of the present invention. Because other enclosure structure is provided for region 22 outside of lighting region 20, solder-mask layer 24 (see also FIG. 3) in region 22 may be used, and solder-mask layer 24 may have a thickness of less than about one-third of the thickness of solder-mask layer 18.

FIG. 3 is a cross-sectional illustration of a portion of circuit board 10 showing layers including board substrate 12 and copper traces 14, an LED package L6, and a standards-satisfying layer 18 of solder mask on lighting region 20 of the board, a thinner layer 24 of solder mask on subregion 30 within lighting region 20, and a thinner layer 32 of solder mask on region 22 outside of lighting region 20.

Solder-mask layers 18, 24 and 32 may all be applied using a silk-screening process. Silk-screening processing can be adjusted to achieve the desired thickness of solder-mask applied at least by varying the number of passes and the mesh-size of the screens used. Modifying the curing strategy, i.e., whether or not curing or partial curing occurs between silk-screening passes, may impact the thickness and nature of the solder mask. It is also anticipated that the selectively-applied dielectric layer such as solder-mask material may be applied by other processes; the use of silk-screening is not intended to limit the scope of the present invention. The invention also contemplates that the selectively-applied dielectric layer, while it may be a single material applied in more than one pass, may instead be more than a single dielectric material applied in multiple-pass application.

While the principles of this apparatus have been described in connection with specific embodiments, it should be understood clearly that these descriptions are made only by way of example and are not intended to limit the scope of the invention.

1. An LED apparatus including:
an electrical circuit board having an electrically-insulated substrate with conductive zones laminated thereon;
a selectively-applied dielectric layer adhered to portions of the circuit board, the dielectric layer having a thickness and material composition sufficient such that the fire and electrical enclosure requirements of UL8750, UL746E and UL746C are met; and
one or more LEDs connected to the circuit board at designated connection sites thereon.

2. An LED apparatus of claim 1 wherein the selectively-applied dielectric layer is a solder mask.

3. The LED apparatus of claim 2 wherein the solder-mask layer comprises Taiyo PSR4000 LEW3.

4. The LED apparatus of claim 2 wherein the solder-mask layer has a thickness in excess of about 60 microns.

5. The LED apparatus of claim 2 wherein the solder mask is applied by a silk-screening process.

6. The LED apparatus of claim 2 wherein the region of the circuit board surrounding the LEDs is a lighting region, and the circuit board further includes non-LED electrical components on one or more areas of the circuit board outside of the lighting region.

7. The LED apparatus of claim 6 wherein the one or more areas outside of the lighting region of the circuit board include a solder-mask layer having a thickness of not more than one-third that of the solder-mask layer on the lighting region.

8. The LED apparatus of claim 7 wherein the solder mask is applied by a silk-screening process.

9. The LED apparatus of claim 6 wherein the lighting region includes one or more subregions which do not include conductive zones, and the subregions include a solder-mask layer having a thickness of not more than one-third that of the solder-mask layer on the lighting region.

10. The LED apparatus of claim 9 wherein the solder mask is applied by a silk-screening process.

11. The LED apparatus of claim 1 wherein the selectively-applied dielectric layer is of a single material.
